(19) United States
(12) Patent Application Publication
(10) Pub. No.: US 2011/0260871 A1
(43) Pub. Date: Oct. 27, 2011

(54) SYSTEM FOR TRACKING A PRESENCE OF PERSONS IN A BUILDING, A METHOD AND A COMPUTER PROGRAM PRODUCT

(76) Inventor: Ireneusz Piotr Karkowski, KM Delft (NL)

(21) Appl. No.: 13/127,542

(22) PCT Filed: Nov. 5, 2009
(86) PCT No.: PCT/NL2009/050668

§ 371 Date: Jun. 27, 2011

(30) Foreign Application Priority Data
Nov. 5, 2008 (EP) 08168353.4

(51) Int. Cl. G08B 21/22

(52) U.S. Cl. 340/573.1; 340/670

(57) ABSTRACT

A system for tracking a presence of persons in a building, a method and a computer program product Abstract The invention relates to a system for tracking a presence of persons in a building. The system comprises a sensor network a computer system that is communicately connected to the sensor network. The sensor network includes a motion sensor for sensing a person's motion in a room of the building, a door sensor for sensing if a door of the room is opened and/or closed, and a localization sensor for sensing if a person is present at a particular location in the room. Further, the computer system includes a processor is arranged for generating a presence state vector indicating a presence probability value of a person in the room, based on sensor information provided by the sensor network.

The invention relates to a system for tracking a presence of persons in a building.

Such tracking systems can e.g. be used as part of a surveillance and home automation system for generating an alarm when a resident of a house, e.g. an elderly person, becomes suddenly ill.

From the prior art, alarm pendants such as alarm buttons, tags or pull cords are known to generate a so-called social alarm. However, the pendant must be carried by the users all the time. In practice, the pendants are not carried due to stigmatizing feelings or just due to forgetting. Pull cords should be installed in impractical large quantities all around the house to offer a good protection level.

Further, wearable fall detectors are known. Also the fall detectors sensing an impact and/or a change in position have to be carried all the time. In practice, fall detectors have a large false alarm rate and do not detect persons shifting slowly down to the floor. Further, they are less suitable for women who do not wear belts.

Also, systems are known that comprise manual switches in the hallway and in the sleeping room indicating whether a resident is at home and possibly sleeping. In combination with motion detectors, inactivity can be sensed. If an inactivity period lasts for more than for example three hours and the switches indicate that the resident is not at home or is not sleeping, an alarm is generated. However, many annoying false alarms are generated and in case of an actual emergency case, the alarm might be too late.

In addition, video processing algorithms are known for processing video camera images to automatically detect falling persons. However, image processing requires much computation power. Further, it is difficult to guarantee proper processing under diverse light conditions. Privacy related issues hamper application of this type of camera applications at home.

Further, it is known from literature, e.g. from the International patent publication WO 2007/079154, to provide a sensing system wherein an alarm signal is generated if a sensed activation is abnormal in view of predefined rules. By recording activities over a certain time, a life style monitoring can be performed. If a change to such a pattern occurs, e.g. when a person wakes up an hour later than usual, an alarm is generated. Again, there is a large latency and false alarms can easily occur as indicated above.

It is an object of the invention to provide a system for tracking a presence of persons in a building, the system providing reliable presence information. Thereto, according to the invention, the system comprises a sensor network including a motion sensor for sensing a persons motion in a room of the building, a localization sensor for sensing if a person is present at a particular location in the room, the system further comprising a computer system that is communicately connected to the sensor network, wherein the computer system further includes a processor that is arranged for generating a presence state vector indicating a presence probability value of a person in the room, based on sensor information provided by the sensor network, and wherein the presence state vector is further based on information of interconnection structures between adjacent rooms in a floor plan of the building.

By employing a motion sensor and a localization sensor, relevant position information of a person being present in a room of a building can be obtained. By collecting this information and by generating a presence state vector indicting a presence probability value of the person in the room, based on information provided by the sensors and on information of interconnection structures between adjacent rooms in a floor plan, the system can provide actual, reliable presence information of a person in a room. Further, advantageously, the system does not require the use of wearable components, thereby enabling the system to operate properly in practice, thereby further improving the operational reliability.

In a preferred embodiment according to the invention, the processor is further arranged for performing the steps of determining fall detection information and generating an alarm signal based on the fall detection information. In an advantageous manner, a fall of a person can be detected in a reliable way based on the generated presence information and sensor information, without the necessity to employ wearable components. By intelligent interpretation of the sensor information, a worrisome home situation can thus be detected, so that a dramatic improvement of situational awareness of emergency personnel can be obtained resulting in more efficient handling of alarms.

The invention also relates to a method of tracking a presence of a person in a building.

Further, the invention relates to a computer program product.

Other advantageous embodiments according to the invention are described in the following claims.

By way of example only, embodiments of the present invention will now be described with reference to the accompanying figures in which

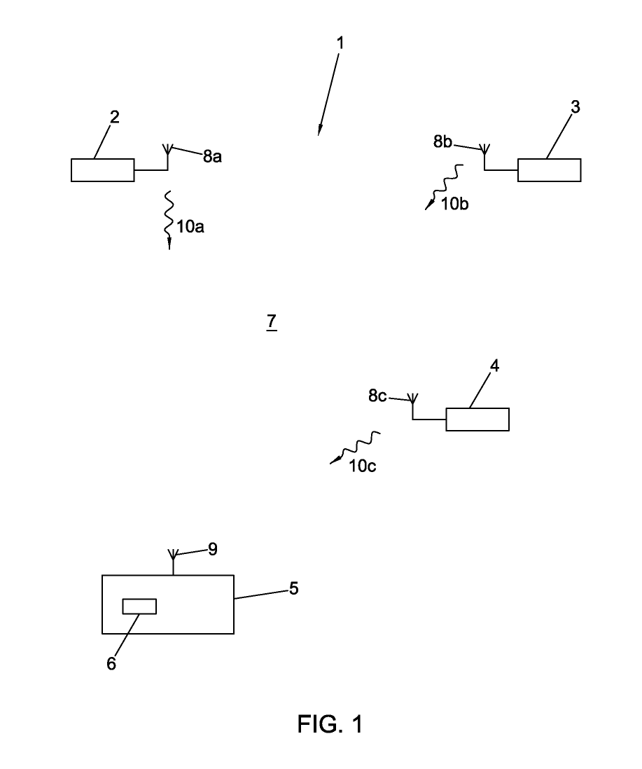

FIG. 1 shows a schematic view of a system according to the invention,

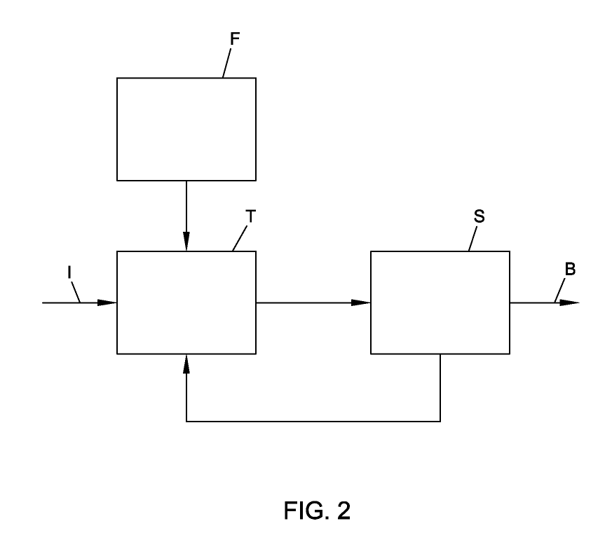

FIG. 2 shows a data flow occurring during performing a first embodiment of a method according to the invention,

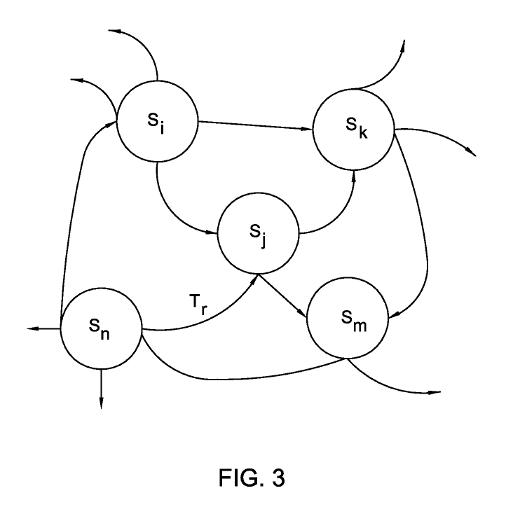

FIG. 3 shows a state diagram,

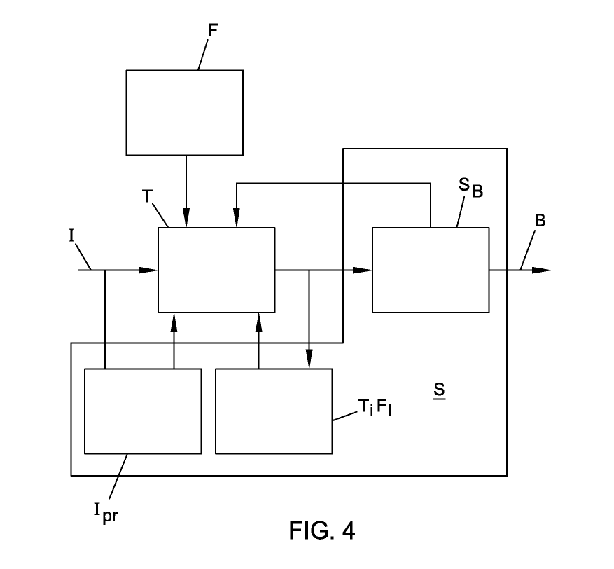

FIG. 4 shows the data flow of FIG. 2 in more detail,

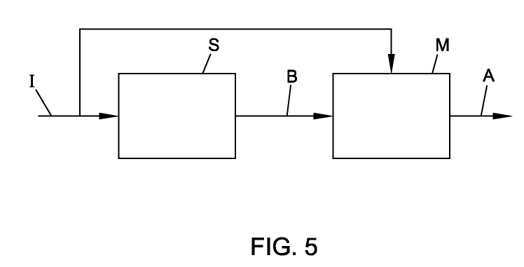

FIG. 5 shows a data flow occurring during performing second embodiment of a method according to the invention, and

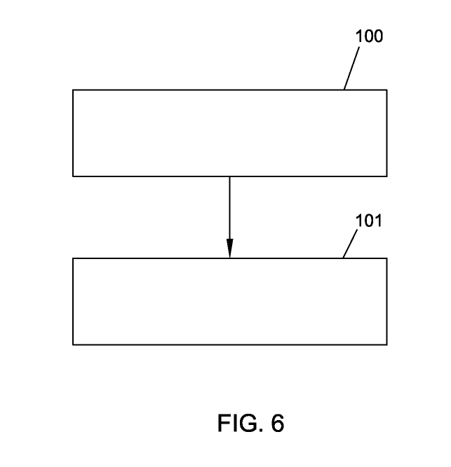

FIG. 6 shows a flow chart of a method according to the invention.

It is noted that the figures shows merely preferred embodiments according to the invention. In the figures, the same reference numbers refer to equal or corresponding parts.

FIG. 1 shows a schematic view of a system 1 according to the invention. The system 1 is arranged for tracking a presence of persons in a building. Thereto, the system 1 comprises a sensor network 2, 3, 4 and a computer system 5 that is communicately connected to the sensor network 2, 3, 4 so that sensed information can be transmitted from the network to the computer system 5.

The sensor network comprises a motion sensor 2 for sensing a person's motion in a room of the building, optionally a door sensor 3 for sensing if a door of the room is opened and/or closed, and a localization sensor 4 for sensing if a person is present at a particular location in the room. The sensors are positioned in a specific room 7 of the building to track a person in said room 7. However, the sensor network can be provided with sensors in further rooms of the building, preferably in all rooms of the building, so that a presence of a person in multiple rooms and preferably in all rooms of the entire building can be tracked. The door sensor 3 is e.g. located near an external door of the building for sensing whether a person enters or leaves the building. In principle however, door sensors might also be employed near internal doors of the building. In this context it is noted that the term “room” indicates a place of the building that is at least partially surrounded by walls, such as a bed room, a living room, a dining room, a kitchen etc, but also a hall. The building is e.g. a resident's home or a complex of apartments. However, the system according to the invention can also be applied in other buildings such as an office to track a presence of persons.

The localization sensor may comprise an occupancy sensor, such as a sensor detecting whether a person occupies a chair, a bed or another furniture. Alternatively or additionally, the localization sensor comprises more generally a sensor detecting whether a person is present at a particular location, e.g. standing in a kitchen. Obviously, the sensor network may comprise further sensors for providing information of the room, e.g. multiple motion sensors, a sensor at each door and/or window for sensing an open/closed state, and/or an occupancy sensor in each chair, sofa and bed.

The sensors comprise a transmitter 8a, 8b, 8c for transmitting, via wireless signals 10a, 10b, 10c sensor information to a receiver 9 that is provided to the computer system 5. In a preferred embodiment, the sensors 2, 3, 4 transmit the sensor information upon a change in sensed information. As an example, the motion sensor 2 transmits information when no motion is detected after a period wherein it is detected that a person makes movements. As a further example, a localization sensor sends information to the computer system 5 when it is detected that a person is sitting down in a chair or when it is detected that the person is leaving the chair. Alternatively, the sensor network can be arranged for transmitting information otherwise, e.g. by transmitting at pre-defined time instants actual sensed information. As an alternative to the wireless sensor network, the sensor network can also be implemented in a wired embodiment, e.g. in order to save cost of components.

The computer system 5 comprises a processor that is arranged for generating a presence state vector indicating a presence probability value of a person in the room or rooms, based on sensor information provided by the sensor network as will be explained in more detail referring to FIG. 2-4.

FIG. 2 shows a data flow occurring during performing a first embodiment of a method according to the invention. A general state vector S comprises a multiple number of state variables including the presence state vector B. For each room that is sensed by the sensor network, a variable of the presence status vector B represents a presence probability value of a person in the room. As an example, the variable can be set to represent either that the person is absent, that there is a small chance that the person is in the room, that the person is almost certainly in the room, that the person is in the room, that it is unknown that the person is in the room. The latter status is e.g. caused by a sensed fact that a door of the room is kept open. Obviously, the variable can represent a person's presence in another way, e.g. by assigning a chance value, e.g. ranging from 0 to 1. The general status vector S may further include other state variables, such as previously received information sensed by the sensor network, flags and/or timers. An example of previously received information is information when a person has left a specific chair in a specific room. A flag contains e.g. information concerning a certain transition in data. Further, a timer can e.g. keep track of a time period after a person's motion is not sensed anymore.

After a computation of the general status vector S, the presence state vector B is made available for further processing, e.g. for generating fall detection information or for storing a person's behaviour. Processing a general status vector is known as a class of rule-based or multi-hypothesis algorithm embedded into a framework of a multi-dimensional state automaton.

An actual general status vector S generally evolutes over time. FIG. 3 shows a state diagram wherein a number of states Sᵢ, Sⱼ, Sₖ, Sₙ, Sₘ are shown together with a number of possible transitions Tr indicated by arrows. In order to model the transitions, a transition function T, see FIG. 2, is applied to perform the transitions of the general status vector S over time. The transition function T receives as input a floor plan of the building, a current general status vector S and sensor information I provided by the sensor network. The processor 6 is arranged to apply said transition function T, so that an update of the general status vector S and the presence state vector B is based on the floor plan F, a current general status vector S and new sensor information I, and optionally on previous sensor information, a timer and/or a flag included in the general status vector. The floor plan F may include a list of all rooms, a list of all internal and external doors, connection information of the doors enabling a passage between adjacent rooms, and a mapping between the sensors and the rooms. The connection information of the doors enabling a passage between adjacent rooms might include information of interconnection structures between adjacent rooms in a floor plan of the building. The interconnection structures information comprises information which doors enable passages between which adjacent rooms. In other words, the presence state vector is generated in an iterative process and is based on a previously generated presence state vector. In principle, also further information can used to apply the transition function T, e.g. information indicating that a person operates a physical device, such as switching on the light in a specific room.

Since the generation of the presence state vector is principally based on the sensor network, a person's presence is tracked without using identification information, thereby respecting privacy of the person.

It is noted that the system according to the invention can be arranged to track a presence of one or a multiple number of persons in a building, based on sensor information provided by the sensor network, to generate a presence state vector B indicating a probability value of one person or a multiple persons in a room or in a multiple number of rooms of the building.

FIG. 4 shows the data flow of FIG. 2 in more detail. More specifically, different components of the general status vector S are shown separately, viz. the presence state vector B, previous sensor information Iₚᵣ and timers and flags TᵢFₗ.

The step of generating the general state vector S including the presence state vector B is either triggered by a modification of information sensed by the sensor network or by the lapse of a pre-determined time interval starting from the moment of generating the previous general state vector. As a result, the general state vector is subjected to a transition if new information of the sensors becomes available or if a pre-determined time interval has lapsed thereby providing actual general state vectors.

As an example, in a process of determining whether a person is still present in a particular room, sensor data might be collected from one or a multiple number of sensors that are located in one or a multiple number of rooms adjacent to the particular room and into which adjacent room(s) the person might enter from said particular room, based on the information of interconnection structures between adjacent rooms in a floor plan of the building. On the other hand, in a process of determining whether a person has entered a particular room, sensor data might be collected from one or a multiple number of sensors that are located in one or a multiple number of rooms adjacent to the particular room and from which adjacent room(s) the person might have left to said particular room, based on the information of interconnection structures between adjacent rooms in a floor plan of the building

FIG. 5 shows a data flow occurring during performing a second embodiment of a method according to the invention. Here, the method comprises the additional steps of determining fall detection information and generating an alarm signal based on the fall detection information, so that a service can be activated to assist the person that might have fallen. In FIG. 5, the presence state vector B is used, together with sensed information I to determine the fall detection information in an additional functional module, also called a mobility monitoring module M that is arranged for generating the alarm signal A when it is deduced, from the available information, that a person could have fallen.

Preferably, the determining step comprises checking presence information of the person at the particular location in the room when a person's motion is not sensed anymore and a pre-determined motion time interval has lapsed without sensing the person's motion again. The presence information at the particular location in the room can be obtained by checking the corresponding information sensed by the locatization sensor. Thus, if a specific motion sensor does not sense any motion of the person after the sensor has sensed such information, the system checks whether the person is at a particular location in the room. Obviously, if the person is present in the particular location, e.g. in a chair, it is not detected, in principle, that the person has fallen, and no alarm signal A has to be generated. By checking the presence information at the particular location after a moment when no motion is sensed anymore, an efficient data processing process can be obtained since the presence information at the particular location needs not be consulted if motion is still detected. A lapse of a pre-determined motion time interval can be determined by a counter that is started after the moment no motion is sensed anymore to filter out noise signals. As an example, the predetermined motion time interval can be set to circa several seconds or several minutes.

Further, the determining step may comprise checking the presence state vector B to learn whether the person should be present in the room or has left the room. Obviously, when a person is not present anymore in the room, in principle, it is not detected that the person has fallen, and no alarm signal A has to be generated. In this respect it is noted that, in principle, there is no preference for a particular checking order. As an example, the step of checking the presence state vector B can be performed after the step of checking whether a person is present at a particular location in the room.

However, if it has been detected that no motion has been sensed anymore, that the person should be present in the room and that the person is not present at the particular location in the room, such as a chair or bed, it can be deduced by the mobility monitoring module M that the person has fallen. Then, an alarm signal A is generated to trigger a service for assisting the fallen person. Advantageously, the alarm signal can be generated in a process wherein no private information, such as images of the person in a private environment, is used.

In an embodiment, the alarm signal is transmitted via a communication system, such as the Internet or a phone network, to a possibly remote alarm system. The alarm system can be operated by emergency personnel to provide adequate handling of alarm situations. After generating the alarm signal, the generating of alarm signals is stopped for a relatively long period, e.g. 30 minutes in order to avoid confusing the alarm system with alarm signals related to situations that are already handled by the alarm system.

After receipt of the alarm signal, it might be decided to switch on video cameras that are optionally included in the system for verification of an emergency situation. By switching the video cameras only on when an alarm signal has been generated, a privacy friendly approach is conducted. Preferably, the switch on operation is performed wirelessly using standard wireless communication devices. The images retrieved by the video cameras can be read remotely by using standard communication technology, thereby enabling the emergency personnel to check whether the person has indeed fallen. Optionally, the video camera is provided with an indicator indicating when it operates, thus providing the resident the ability to check whether the video camera is on or off.

Then, as an option, before sending the alarm to the emergency services, it might be decided, either automatically or by a person, to contact the person in the building by telephone, either via Internet or via a standard voice communication channel, a POTS line. A specific pre-recorded sequence of audio fragments can be played back. The resident may react or answer questions by using buttons of the phone. Alternatively, e.g. after sending the alarm, a life conversation can be set up to learn the situation. As a result, false alarms can be stopped and the resident maintains control over the system. Further, no new communication device is needed.

In order to counteract a situation wherein the system does not operate properly, e.g. due to a power drop down or an interruption in the communication between the local system in the building and the remote alarm system, a period check signal, also called a heartbeat signal, can be send from the local system to the alarm system of the emergency services.

Further, after receipt of the alarm signal, the alarm system may switch off audio devices and/or buzzers in the room where the fallen person is present, in order to improve communication with said person. Also, other devices, such as light system can be switched on remotely.

FIG. 6 shows a flow chart of a method according to the invention. The method comprises the steps of sensing (100) presence information and generating (101) a presence state vector indicating a presence probability value of the person in the room, based on the sensed presence information and on information of interconnection structures between adjacent rooms in a floor plan of the building. The sensing step may include the substeps of sensing a person's motion in a room of the building, sensing if a door of the room is opened and/or closed, and sensing if the person is present at a particular location in the room.

The method of tracking a presence of persons in a building, and especially the steps of receiving the sensed presence information from the sensor network and generating a state vector indicating a presence probability value of the person in the room, based on the sensed presence information, can be performed on the processor, using dedicated hardware structures, such as FPGA and/or ASIC components. Otherwise, the method can also at least partially be performed using a computer program product comprising instructions for causing a processor of the computer system to perform the above described steps of the method according to the invention.

The invention is not restricted to the embodiments described herein. It will be understood that many variants are possible.

Optionally, the computer system is provided with a transmitter, e.g. for requesting specific sensed information from one or a multiple number of sensors.

Other such variants will be obvious for the person skilled in the art and are considered to lie within the scope of the invention as formulated in the following claims.

1. A system for tracking a presence of persons in a building, comprising:
a sensor network including:
a motion sensor for sensing a person's motion in a room of the building,
a localization sensor for sensing if a person is present at a particular location in the room, and
a computer system that is communicately connected to the sensor network, wherein the computer system further includes a processor that is arranged for generating a presence state vector indicating a presence probability value of a person in the room, based on sensor information provided by the sensor network, and wherein the presence state vector is further based on information of interconnection structures between adjacent rooms in a floor plan of the building.

2. A system according to claim 1, wherein the localization sensor comprises an occupancy sensor and/or wherein the sensor network includes a further sensor providing information of the room.

3. A system according to claim 1, wherein the sensor network further includes a door sensor for sensing if an external door of the building is opened and/or closed.

4. A system according to claim 1, wherein the sensor network includes sensors for providing presence information of multiple rooms of the building and wherein the presence state vector indicates a presence probability value of a person in said multiple rooms.

5. A system according to claim 1, wherein the sensor network is wireless.

6. A method of tracking a presence of persons in a building, comprising the steps of:
sensing presence information, including the substeps of:
sensing a person's motion in a room of the building, and
sensing if a person is present at a particular location in the room,
generating a presence state vector indicating a presence probability value of a person in the room, based on the sensed presence information, and wherein the presence state vector is further based on information of interconnection structures between adjacent rooms in a floor plan of the building.

7. A method according to claim 6, further comprising collecting data from a sensor that is located in a room or rooms adjacent to a particular room, into which adjacent room a person might enter from said particular room.

8. A method according to claim 6, wherein the presence state vector is further based on a previously generated presence state vector.

9. A method according to claim 6, wherein the presence state vector is based on previous sensor information, a timer and/or a flag.

10. A method according to claim 6, wherein the presence state vector indicates a presence probability value of a multiple number of persons in the room and/or rooms of the building.

11. A method according to claim 6, wherein the step of generating the presence state vector is triggered by a modification of sensed information or by the lapse of a pre-determined time interval starting from the moment of generating the previous presence state vector.

12. A method according to claim 6, further comprising the steps of:
determining fall detection information, and
generating an alarm signal based on the fall detection information.

13. A method according to claim 12, wherein the determining step comprises checking presence information of the person at the particular location in the room when a person's motion is not sensed anymore and a pre-determined motion time interval has lapsed without sensing the person's motion again.

14. A method according to claim 12, wherein the determining step comprises checking the presence state vector.

15. A computer program product comprising computer readable code for causing a processor to perform a method for tracking a presence of persons in a building, the method comprising the steps of:
receiving sensed presence information, the information including:
information of a person's motion in a room of the building, and
information if a person is present at a particular location in the room,
generating a presence state vector indicating a presence probability value of a person in the room, based on the sensed presence information, and wherein the presence state vector is further based on information of interconnection structures between adjacent rooms in a floor plan of the building.

16. A system according to claim 2, wherein the sensor network further includes a door sensor for sensing if an external door of the building is opened and/or closed.

17. A method according to claim 7, wherein the presence state vector is further based on a previously generated presence state vector.

18. A method according to claim 13, wherein the determining step comprises checking the presence state vector.

19. A system according to claim 2, wherein the sensor network is wireless.

20. A system according to claim 3, wherein the sensor network is wireless.
